(19) United States
(12) Patent Application Publication
(10) Pub. No.: US 2017/0140771 A1
(43) Pub. Date: May 18, 2017

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventors: Toru TANIGUCHI, Yokohama (JP); Yu NASU, Tokyo (JP)

(21) Appl. No.: 15/261,254

(22) Filed: Sep. 9, 2016

(30) Foreign Application Priority Data
Nov. 17, 2015 (JP) 2015-224864

(51) Int. Cl. G10L 21/028; G10L 15/05

(52) U.S. Cl. CPC G10L 21/028; G10L 15/05; G10L 2021/02166

(57) ABSTRACT

According to one embodiment, an information processing apparatus includes a detector, a calculator and a generator. The detector detects a segment in which a keyword is included, based on at least one of input acoustic signals input from M (an integer equal to or greater than two) voice input units. The calculator calculates an M×M spatial feature matrix including acoustic characteristics of a space including a first sound source of interest and a second sound source other than the first sound source, and acoustic characteristics based on positional relation between the voice input units and one or more of the first sound source and the second sound source, based on the input acoustic signals and the segment. The generator generates a spatial filter for obtaining an acoustic signal from the input acoustic signals, based on the spatial feature matrix, the acoustic signal being output from the first sound source.

### CROSS-REFERENCE TO RELATED APPLICATIONS

This application is based upon and claims the benefit of priority from Japanese Patent Application No. 2015-224864, filed on Nov. 17, 2015; the entire contents of which are incorporated herein by reference.

### FIELD

Embodiments described herein relate generally to an information processing apparatus, an information processing method, and a computer program product.

### BACKGROUND

Techniques are proposed for obtaining the sound source direction (an example of positional features) of desired target sound by detecting a certain keyword spoken by a user and estimating the speech direction (utterance position) from acoustic signals in the estimated keyword speech segment. Techniques are also proposed for generating a spatial filter for obtaining target sound by suppressing sound in other directions based on the thus-obtained sound source direction. Conventional examples are described in Japanese Unexamined Patent Application Publication (Translation of PCT Application) No. 2005-529379, Japanese Patent No. 4837917, and Japanese Patent Application Laid-open No. 2014-041308.

### BRIEF DESCRIPTION OF THE DRAWINGS

FIG. 1 is a block diagram illustrating a functional configuration example of an information processing apparatus of a present embodiment:

FIG. 2 is a diagram illustrating an example of the detected keyword speech segment;

FIG. 3 is a diagram illustrating the detected non-voice segment and voice segment;

FIG. 4 is a flowchart illustrating an example of the voice processing in the present embodiment;

FIG. 5 is a flowchart illustrating another example of the voice processing in the present embodiment; and

FIG. 6 is a diagram illustrating a hardware configuration example of the information processing apparatus according to the present embodiment.

### DETAILED DESCRIPTION

According to one embodiment, an information processing apparatus includes a detector, a calculator and a generator. The detector detects a segment in which a keyword is included, based on at least one of input acoustic signals input from M (an integer equal to or greater than two) voice input units. The calculator calculates an M×M spatial feature matrix including acoustic characteristics of a space including a first sound source of interest and a second sound source other than the first sound source, and acoustic characteristics based on positional relation between the voice input units and one or more of the first sound source and the second sound source, based on the input acoustic signals and the segment. The generator generates a spatial filter for obtaining an acoustic signal from the input acoustic signals, based on the spatial feature matrix, the acoustic signal being output from the first sound source.

Preferred embodiments of an information processing apparatus according to the present invention will be described in details below with reference to the accompanying drawings. The information processing apparatus of the present embodiment is an apparatus that generates a spatial filter as described above. The information processing apparatus of the present embodiment is applicable to, for example, noise removing devices using a spatial filter to remove noise other than target sound, voice recognition devices recognizing voice based on noise-free sound, and voice processing devices performing processing based on recognized voice.

First of all, main terms used will be described below,
acoustic signal: refers to a signal obtained by observing a compression wave propagating through a medium in a space such as the air with one microphone and converting the compression wave into an electrical signal. In the present embodiment, the electrical signal digitalized by an analog-digital (AD) converter is used. The acoustic signal is represented as a one-dimensional time-series.
microphone array: a device including an arrangement of a plurality of microphones for observing acoustic signals at a plurality of points in a space. The acoustic signals observed at the points are different even at the same time, depending on the sound source position and acoustic characteristics of the space. A spatial filter can be implemented by using these acoustic signals appropriately,
spatial filter: refers to signal processing (signal processing device) used for suppressing or enhancing an acoustic signal from a sound source existing in a certain region in a space (typically, a certain direction as viewed from the microphone array) or parameters (such as a set of numerical values) that determine the operation of this signal processing. The spatial filter receives input of a plurality of acoustic signal sequences observed by a microphone array and outputs one or more sequences of suppressed or enhanced acoustic signals.
beam former: refers to a multi-channel signal processing technique for designing a spatial filter. Alternatively, it refers to signal processing by a spatial filter formed by the multi-channel signal processing technique.
(linguistic) voice (signal): refers to an acoustic signal including linguistic information that is produced from a human.
voice recognition: refers to a technique converting linguistic voice included in an acoustic signal into text.
(voice) keyword detection: refers to detection of voice of a certain word (keyword) from input of an acoustic signal.
SNR, SN ratio (Signal to Noise Ratio): an abbreviation of signal to noise ratio or voice to noise ratio. A value consisting of a denominator representing average energy of a noise signal and a numerator representing average energy of a target signal (voice). The greater the value is, the greater the energy of the target signal is.
transfer function: refers to a function representing the relation between the sound source position and the observation position of an acoustic signal propagating from a sound source and observed at a microphone (observation point).
sound source spatial feature: the feature amount including both of acoustic characteristics based on the positional relation between a sound source and a microphone array and acoustic characteristics of a space including the sound source and the microphone array.
target sound source spatial feature (first spatial feature): refers to the sound source spatial feature of a sound source of interest (target sound source, first sound source).
non-target sound source spatial feature (second spatial feature): refers to the sound source spatial feature of a sound source other than the target sound source (non-target sound source, second sound source).

An overview of the present embodiment will now be described. We will examine a voice capturing technique for hands-free voice recognition technique. The hands-free voice recognition technique is used for, for example, operating a device only with an instruction via voice from a location distant from the device. Due to constraints in implementation of the device, it is assumed that the device itself contains a microphone. Voice produced at a distance significantly attenuates before reaching the microphone. This reduces the SNR to the surrounding noise when compared with a case where the microphone is close to the device user. In addition, the voice is more affected by echoes (reverberation) from wall surfaces, floors, and ceilings. It is known that the accuracy of voice recognition is significantly reduced for those reasons.

This problem may be addressed by, for example, multi-channel signal processing using a plurality of signals observed by a microphone array (hereinafter referred to as microphone array signal processing) to suppress noise and reverberation. Such an approach enables acquisition of a higher-quality acoustic signal of target sound produced by a user. This is an effect expected from that the microphone array signal processing forms an appropriate spatial filter, namely, that distortion of sound coming from the direction of a target sound source (target sound source direction) is minimized while suppression of an acoustic signal produced from a position other than the target sound is maximized.

The question here is how to differentiate target sound unknown as to where in the environment it is produced, from other noise produced from various positions, and obtain positional features necessary for spatial filter formation. As one solution to this, the technique as described above can be applied that detects a certain keyword to obtain the sound source direction as one of positional features.

In order to form a spatial filter for obtaining target sound, the direction of target sound has to be determined in advance during system designing or estimated by the system by a different method. If a technique for obtaining the direction and the position at the time of utterance of a certain keyword is applied, accurate voice input from any given direction should he achieved as long as a user speaks a certain keyword.

Unfortunately, in actuality, the effects of noise and/or indoor reverberation may cause an error in the estimation result of the target sound source direction during keyword utterance. Even if the direction estimation is accurately performed, the output accuracy of the spatial filter may be reduced, leading to reduction in noise suppression performance or to distortion in target voice.

In an ideal environment free from reverberation, the transfer function between target sound and a microphone array, which is ultimately used in designing of a spatial filter, is determined only by the distance between microphones of the microphone array and the sound source direction. The feature of the sound source position thus can be represented by information of a single value of the sound source direction. In a real environment with reverberation, however, the transfer function experiences effects that vary with frequencies, due to the effects of reverberation. It is therefore required to express the features related to the position of target sound, not with a small number of values such as direction and position but with a transfer function itself that has a frequency-by-frequency value.

However, it is generally difficult to estimate the transfer function itself from a mixed signal of a target sound source and a non-target sound source. Japanese Unexamined Patent Application Publication No. 2005-529379 proposes a technique using voice/non-voice detection (voice activity detection (VAD)) to estimate the transfer functions of the target sound source and noise to be used in noise suppression. The technique of Japanese Unexamined Patent Application Publication No. 2005-529379, however, is on the premise of a special situation in which these sound sources can be exclusively observed.

The present embodiment then enables designing of a spatial filter in common situations in which target sound and non-target sound are observed in a mixed state, using detailed information of the transfer function on a frequency-by-frequency basis. The present embodiment uses the sound source spatial feature (target sound source spatial feature or non-target sound source spatial feature) represented by a set of positive-semidefinite matrices corresponding to each frequency in connection with the position and the spatial acoustic feature of target sound or non-target sound.

Details of the present embodiment will now be described.

Observation model and spatial filter

First, in preparation for a description of related arts and the present embodiment, an observation model of the intended acoustic signal and a spatial filter will be described.

Assume that K (K is an integer equal to or greater than two) not-moving sound sources are given. The acoustic signal (sound source signal) at a discrete time t at the sound source position of the k-th (1≦k≦K) sound source is denoted by sₖ(t), and of M (M is an integer equal to or greater than two) microphones in a microphone array, the observation signal at the m-th (1≦m≦M) microphone position is denoted by x_{k,m}(t). It is noted that a similar technique can be applied to a moving sound source. Equation (1) below represents x_{k,m}(t):

$${x}_{k , m} ( t ) = {\sum }_{τ = 0}^{{T}_{RIR}} {h}_{k , m} ( τ ) {s}_{k} ( t - τ ) \qquad ( 1 )$$

where h_{k,m}(T) is an impulse response from the sound source k to the microphone m. The length of the impulse response is T_{RIR}. It is assumed that acoustic spatial characteristics including the position of the sound source and the position of the microphone array are not changed.

Equation (1) expressed with a frequency domain is written as Equation (2) below:

x_{k,m}(ω, n)≈a_{k,m}(ω)Sₖ(ω, n) (2)

where x_{k,m}(ω, n), a_{k,m}(ω), sₖ(ω, n) are complex numbers and obtained by short-time Fourier transform of x_{k,m}(t), a_{k,m}(t), sₖ(t), respectively; a_{,m},ₘ(ω) is called a transfer function between the sound source k and the microphone m and is a time-invariant complex number; n is each frame time of the short-time Fourier transform; and ω is frequency.

Here, the window length of the short-time Fourier transform is preferably equal to or wider than the length of T_{RIR}. For appropriate modeling, T_{RIR} need to be roughly equivalent to the reverberation time and has a score of about 0.5 second in typical offices or house living rooms. In actuality, a shorter window length is often used instead, and in this case, an error is produced between the left side and the right side of Equation (2).

Although a_{k,m}(ω) includes a time delay or attenuation in amplitude according to the distance between the sound source and the microphone, there is no problem if it is a relative value to a certain microphone, in the signal processing described below. That is, there is no problem in practice if a_{k,m}(ω)/a_{k,1}, (ω) is replaced by a_{k,m}(ω). Such a_{k,m}(ω) are arranged for each sound source to form a vector aₖ(ω)=[a_{k,1}(ω), a_{k,2}(ω), . . . , a_{k,m}(ω)]^{T}, which is called a steering vector of the microphone array for the sound source k. T represents the transpose of a vector and a matrix.

The steering vector represents the position of the sound source as viewed from the microphone array. The steering vector is greatly affected also by spatial, acoustic characteristics of the environment (such as rooms). The steering vector therefore has a different value even with the same distance and direction of the sound source as viewed from the microphone array, for example, when the microphone array is placed in a different room or at a different position in the same room.

On the other hand, the mixed sound xₘ(ω,n) actually observed by the microphone m is represented as in Equation (3)below:

$${x}_{m} ( ω , n ) = {\sum }_{k = 1}^{K} {x}_{k , m} ( ω , n ) . \qquad ( 3 )$$

By substituting Equation (2) in Equation (3) and expressing the equation with matrix and vector, the observation signal x(ω,n) is represented by Equation (4) below:

$$x ( ω , n ) = {\sum }_{k = 1}^{K} {a}_{k} ( ω ) {s}_{k} ( ω , n ) = A ( ω ) s ( ω , n ) \qquad ( 4 )$$

where x(ω, n) =[x₁(ω,n), x₂(ω, n), . . . , x_{M}(ω, n)]^{T}; mixing matrix A(ω)=[a₁(ω), a₂(ω), . . . , aₖ(ω)]^{T}; and s(ω, n)=[S₁(ω, n), s₂(ω, n), . . . , sₖ(ω, n)]^{T}.

By appropriately determining the spatial filter matrix W (ω) for the observation signal, the estimated value of the original sound source signal can be obtained by Equation. (5) below:

ŝ(ω, n)=W(ω)×(ω, n) (5).

In this case, for example, if the mixing matrix A(ω) is known, W(ω)←A(ω)⁺ can be estimated. “+” is an operator representing a pseudo-inverse matrix. In actuality, A(ω) as a whole is rarely known. The reason for this is that it is difficult to know the positional relations between the microphone array and all of the sound sources including noise sources in advance, and that even if those positions are known, there are effects of the spatial acoustic characteristics of the environment. Common sound capturing devices including the present embodiment are intended to be used in various environments, and it is difficult to know spatial acoustic characteristics in advance. Then, W(ω) is usually adaptively estimated, for example, from the observation signal x(ω,n) in Equation (4).

When each row of the spatial filter matrix is represented by a row vector with M dimensions, such as W(ω) =[w₁^{H}(ω), w_{z}^{H}(ω), . . . , Wₖ^{H}(ω)]^{T}, the k-th sound source can be estimated as Equation (6) below. H is an operator representing a Hermitian transpose.

sₖ(ω, n)=wₖ^{H}(ω)×(ω, n) (6)

Since actual applications rarely require a spatial filter matrix as a whole, the spatial filter wₖ^{H}(ω) for the sound source k of interest is directly computed and used. In the following, the frequency in Equations will be omitted as appropriate for simplicity.

### Conventional Spatial Filter Control Method

A conventional method for obtaining the spatial filter wₖ^{H} for the sound source k will be introduced. Hereinafter, k is omitted, and the spatial filter is denoted as w^{H}.

Supposing that the steering vector a of the target sound source is known, the spatial filter w_{MV}^{H} can be computed as in Equation (7) below using the minimum variance distortionless response (MVDR) method:

$${w}_{MV}^{H} = \frac{{R}^{- 1} a}{{a}^{H} {R}^{- 1} a} \qquad ( 7 )$$

where R is represented by Equation (8) below; and E[] represents the expected value.

R=E[x(nx^{H}(n)] (8)

R is hereinafter called the spatial covariance matrix of the observation signal. R represents spatial characteristics including both of the acoustic characteristics of the target sound source and noise based on the position with reference to the microphone array and the acoustic characteristics of the space including the target sound source and noise. The spatial covariance matrix R is known to be always in the form of a positive-semidefinite matrix. Although the observation signal for a long time is necessary for accurately obtaining R defined as an expected value, in practice, R is estimated as appropriate from moving averages of the observation signal in the past.

When the steering vector a and R are correct, the minimum variance distortionless response method can maximize suppression of other noise under a condition that a signal coming from the target sound source is not distorted. On the other hand, when the steering vector has an error, the minimum variance distortionless response method has a disadvantage of distorting the target sound source. Similar spatial filters can be implemented using, for example, a generalizing side lobe canceller, but have the same problem as in the minimum variance distortionless response method.

Estimation of steering vector and sound source-arrival direction

In order to implement the spatial filter control method described above, it is necessary to estimate a steering vector corresponding to the sound source. Here, we will examine the estimation from observation (acoustic) signals including a target sound source.

The steering vector should be determined for each frequency band. The steering vector is determined only by a signal arrival time difference, which is determined by the positional relation between each microphone of the microphone array and the target sound source, when there are no effects of sound diffraction due to the microphone array housings and room reverberation- For example, when the arrival time difference (delay) from the microphone I to the microphone m of a signal from the sound source at a position p is τ (p, m) seconds, the steering vector a(ω,p) of frequency can be easily written as Equation (9) below only using the frequency and the arrival time difference:

a(ω, p)=[1, . . . , e^{-jωτ(p,m)}, . . . ]^{T} (9)

This arrival time difference can be approximately associated with the direction of the sound source as viewed from the microphone array when the sound source is sufficiently far from, the microphone (array). Conventionally, direction (position) estimation or arrival time difference estimation has been used alternatively in estimation of the steering vector, by representing the feature of the sound source position by one or two values of direction or two or three values including distance, rather than individually obtaining steering vectors on a frequency-by-frequency basis.

Known methods of the arrival time difference or sound source direction estimation include the delay and sum array method, the multiple signal classification (MUSIC) method, and the generalized cross-correlation method with phase transform (GCC-PHAT). Some of the methods make an estimation on a frequency-by-frequency basis and use integration of the results integrated for all frequencies.

In real environments, however, as described above, the steering vector is affected by sound diffraction of the microphone array casing and room reverberation and is not necessarily represented by a small number of values such as the direction (position) and the arrival time difference.

In addition, an error occurs in the direction estimation due to the effects of background noise (non-target sound source). It may be good to directly estimate the steering vector instead of direction and position, but it is still difficult under background noise. Furthermore, when the window length of fast Fourier transform (FFT) is not sufficient due to the approximation in a frequency domain in Equation (2) and, in particular, room reverberation is large, or when the sound source is at a distance and the effect of rear reverberation is large, the error in the model of Equation (2) is large, in the first place. As a consequence, the discussions made so far based on this model fail to estimate a sound source signal with sufficient accuracy. Although there is a discussion suggesting that a sufficiently large FFT window length should be set, it is difficult to know the length T_{RIR} of the impulse response corresponding to the FFT window length in advance, because it depends on spatial acoustic characteristics of environments (for example, room). In addition, setting a long time length such as 0.5 second is often unrealistic for the reason of computational efficiency.

On the other hand, it is known that even in a case where the modeling in Equation (2) causes an error, the sound source can be estimated more accurately by obtaining the spatial covariance matrix illustrated by Equation (8) from the observation signals from individual sound sources. The spatial covariance matrix can express the spatial feature of a number of sound sources and of a sound source that is a single sound source but considered as a number of sound sources due to the effect of reverberation, with a set of features. For example, in the MUSIC method, direction estimation is performed by explicitly obtaining the main components of this spatial covariance matrix. For spatial filter estimation, directly using the spatial covariance matrix is known to be more accurate.

For the target sound source, the present embodiment then uses the estimated value of the spatial covariance matrix as illustrated by Equation (8) as the spatial feature of the sound source, rather than using representative values such as direction and position and the steering vector of each sound source.

### Configuration Examples of the Present Embodiment

As discussed so far, in the present embodiment, the spatial filter is controlled by using the sound source spatial feature of each sound source as represented by a set of positive-semidefinite matrices extracted from observation signals including signals coming from the target sound source and the non-target sound source, instead of using the estimated target sound source direction or position.

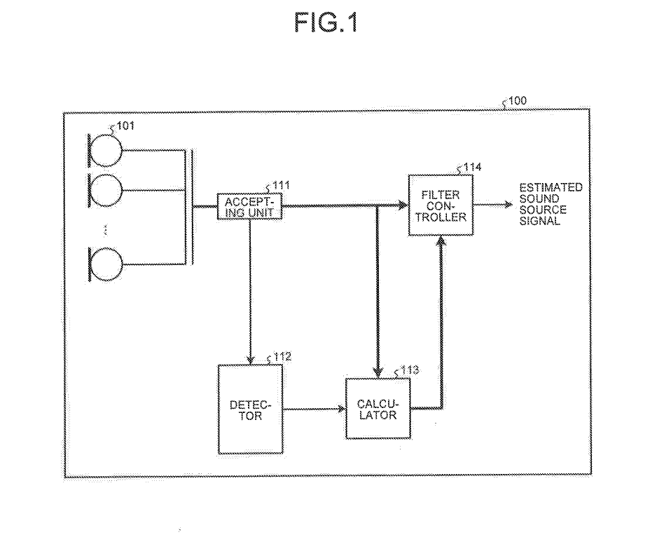

FIG. 1 is a block diagram illustrating a functional configuration example of the information processing apparatus of the present embodiment. As illustrated in FIG. 1, the information processing apparatus 100 includes a microphone array 101, an accepting unit 111, a detector 112, a calculator 113, and a filter controller 114.

The microphone array 101 is configured with an arrangement of a plurality of microphones (voice input units) for inputting voice as described above. The microphone array 101 can be used to estimate a sound source direction and form a spatial filter. A plurality of microphones need not be aligned. For example, when the estimation of a sound source direction is not necessary, a plurality of microphones disposed at any positions may be used.

The accepting unit 111 accepts input of a plurality of acoustic signals (input acoustic signals) from a plurality of microphones included in the microphone array 101. The detector 112 detects a segment in which a certain keyword is output (keyword speech segment), based on a plurality of input acoustic signals input from the respective voice input units.

The calculator 113 estimates (calculates) sound source spatial feature (spatial feature matrix) represented by a set of positive-semidefinite matrices, based on a plurality of input acoustic signals and the keyword speech segment. The sound source spatial feature is a feature amount including acoustic characteristics of a space at least including a sound source and the microphone array 101, as described above. The calculator 113 estimates, for example, at least one of the target sound source spatial feature (first spatial feature matrix) and the non-target sound source spatial feature (second spatial feature matrix) represented by a set of positive-semidefinite matrices.

The filter controller 114 controls the processing of generating a spatial filter based on the estimated sound source spatial feature (at least one of the target sound source spatial feature and the non-target sound source spatial feature). For example, the filter controller 114 functions as a generator that generates a spatial filter for obtaining an acoustic signal output from a target sound source from a plurality of input acoustic signals. The filter controller 114 outputs the acoustic signal of the target sound source (estimated sound source signal) that is obtained by the generated spatial filter.

In this manner, the present embodiment differs from the related arts in that the sound source spatial feature is estimated and the spatial filter is controlled by using the sound source spatial feature, rather than estimating the direction or position of the target sound source and the steering vectors.

It is noted that the accepting unit 111, the detector 112, the calculator 113, and the filter controller 114 may be implemented, for example, by causing a processing device such as a central processing unit (CPU) to execute a computer program, that is, by software, or may be implemented by hardware such as an integrated circuit (IC), or may be implemented by a combination of software and hardware.

Estimation of sound source spatial feature

First, a method of estimating a sound source spatial feature will be described. As described above, the detector 112 detects a keyword speech segment based on a plurality of input acoustic signals being input. The detector 112 can detect a keyword speech segment by applying any detection method conventionally used, for example, by comparison with the pattern of the acoustic signal of a predetermined certain keyword.

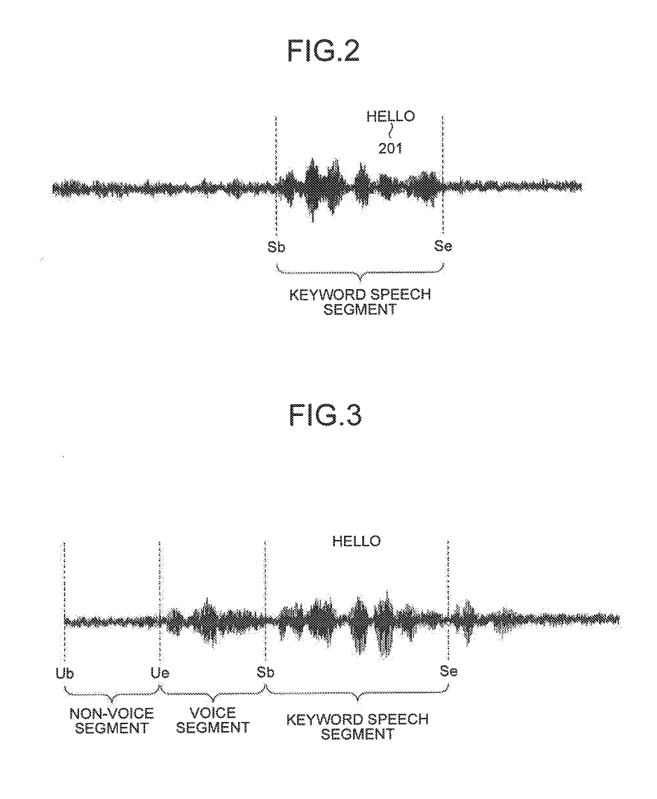

FIG. 2 is a diagram illustrating an example of the detected keyword speech segment. As illustrated in FIG. 2, an utterance beginning time Sb and an utterance end time Se for a certain keyword 201 (“Hello”) are specified in the observation signal.

The calculator 113 calculates spatial covariance for the observation signal in the keyword speech segment as in Equation (10) below:

$${R}_{3} = {\sum }_{n = {S}_{b}}^{{S}_{c}} x ( n ) {x}^{H} ( n ) . \qquad ( 10 )$$

The observation signal in the keyword speech segment can be expected to include the utterance voice of the user (target user) serving as a target sound source and background noise other than the target sound source. The spatial covariance Rₛ is therefore thought to include the spatial features of both of them. In the present embodiment, spatial covariance is used as an example of the sound source spatial feature, and the spatial covariance Rₛ computed from the keyword speech segment is used as an example of the target sound source spatial feature.

Depending on the characteristics of the detector 112, the estimated keyword speech segment may be before or after the actual keyword speech segment. Then Sb and Se may be shifted forward or backward in accordance with the characteristics, by a certain method, for example, by adding or subtracting a certain time to/from Sb and Se as appropriate.

The non-target sound source spatial feature resulting from a sound source (non-target sound source) other than utterance of a target user is also useful in control of the spatial filter. The calculator 113 can estimate the non-target sound source spatial feature, for example, using the observation signal, excluding the keyword speech segment, that supposedly does not include the utterance of the target user.

In control of the spatial filter, only one of the target sound source spatial feature and the non-target sound source spatial feature may be used, or both of them may be used. The calculator 113 estimates at least one of the target sound source spatial feature and the non-target sound source spatial feature that is required for control of the spatial filter.

When using the observation signal previous to the keyword speech segment is contemplated, the immediately preceding voice segment is ignored, because it may be possibly the target user's utterance, and only the non-voice segment previous to the immediately preceding voice segment may be used. In this case, for example, the detector 112 may be configured to detect a voice segment and a non-voice segment, for example, using the voice activity detection (VAD) technique. FIG. 3 is a diagram illustrating the detected non-voice segment and voice segment.

The calculator 113 can calculate the spatial covariance Rᵤ corresponding to the non-target sound source spatial feature, for example, as in Equation (11) below, using the observation signal in the detected non-voice segment [Ub, Ue]:

$${R}_{U} = {\sum }_{n = {U}_{b}}^{{U}_{e}} x ( n ) {x}^{H} ( n ) . \qquad ( 11 )$$

The non-voice segment may not be before (previous to) the keyword speech segment. The non-target sound source spatial feature may be estimated using the observation signal after (subsequent to) the keyword speech segment or using both of the previous observation signal and the subsequent observation signal.

In this way, when the spatial covariance matrix is selected as the sound source spatial feature, the sound source spatial feature is L sets of complex positive semidefinite matrices with a size of M×M. L is the FFT window length, and M is the number of microphones in the microphone array 101.

### Efficient Estimation of Sound Source Spatial Feature

When the information processing apparatus of the present embodiment is used as a voice user interface, it is preferable to control the spatial filter with a minimum delay from the user's utterance. In order to do so, the detector 112 and the calculator 113 may perform sequential processing while referring to the observation signal at the present time (second time) and the past time (first time) in synchronisation with input of the observation signal of the microphone array 101. In doing so, it is desired to minimize the amount of use of storage area due to constraints of the apparatus.

However, the keyword speech segment required in the calculator 113 is not detected until the end of the actual keyword utterance is approached. For example, the detector 112 determines the estimated time (Sb)of the beginning of the keyword speech segment immediately before the utterance end time Se in FIG. 2, at the earliest. After elapse of a certain time from Se, the estimated time (Se) of end of the keyword speech segment is determined. This determination timing may vary depending on the algorithm of the detector 112 but is the same in that Sb is determined far behind the beginning of the actual keyword.

Therefore, to compute the spatial covariance of the target sound source spatial feature according to Equation (10), the observation signal longer than the expected keyword utterance length has to be always stored in a storage area. To compute the non-target sound source spatial feature in Equation (11) from the observation signal at a time before the keyword speech segment, the observation signal for even longer time has to be stored. This is not realistic with some hardware implementation contemplated.

Then, instead of Equation (10), spatial covariance Rₛ (n) of the target sound source spatial feature at present time n may be computed using spatial covariance Rₛ(n−1) one-time in the past, as in Equation (12) below. Here, αₛ is a real number that satisfies 0≦αₛ<1. In the following, αₛ is referred to as forgetting factor.

Rₛ(n)=αₛRₛ(n−1)+(1−αₛ)x(n)x^{H}(n) (12)

When Equation (12) is used, the signal for a long time in the past need not be stored, because what is required is only the spatial covariance Rₛ(n−1) one-time in the past and the observation signal at the present time. For example, by setting αₛ always at a fixed value, the effect of the observation signal in the past decreases as the time passes. Accordingly, the similar result can be expected as when spatial covariance Rₛ in the immediately preceding fixed segment including the present time is computed. It has been confirmed that there is no problem in practice in replacing Equation (10) by Equation (12).

The length of the keyword speech segment varies with keywords and utterance but can be adjusted by reducing αₛ when the estimated utterance length of a keyword is longer, or by increasing αₛ when the estimated utterance length of a keyword is shorter. The detector 112 may retain a plurality of utterance segment candidates until the beginning (Sb) of a keyword is detected. The calculator 113 may dynamically change a in Equation (12) using the beginning time of the utterance segment candidate retained at present. For example, the calculator 113 may perform processing, for example, by reducing αₛ when the beginning time of the candidate retained at present in the detector 112 is earlier than expected, or conversely by increasing αₛ when it is later than the expected time.

The calculator 113 performs VAD on the observation signal at the present time and computes the non-target sound source spatial feature, using the observation signal at the time determined to be “not voice” by VAD, for example, as in Equation (13) below. Here, αᵤ is a real number that satisfies 0≦αᵤ<1. For example, αᵤ is set to an appropriate fixed value in advance.

$$( 13 )$$

$$\{ \begin{matrix}{R}_{U} ( n ) = {α}_{U} {R}_{U} ( n - 1 ) + ( 1 - {α}_{U} ) x ( n ) {x}^{H} ( n ) & ( if not voice ) \\ {R}_{U} ( n ) = {R}_{U} ( n - 1 ) & ( else )\end{matrix} \}$$

The computation method equivalent to Equation (13) may be dynamically changed, for example, by increasing/decreasing αᵤ using a score representing “non-voice-likeness” of the observation signal at the present time that is output by VAD.

When the determination of VAD is used alone, if voice other than target voice is observed, this voice is removed from the computation of the non-target sound source spatial feature. The calculator 113 then may determine that the sound source is other than the keyword speech segment, using other information such as the estimation result of sound source direction. In this case, in Equation (13), the observation signal at the “not target voice” time is used instead of the observation signal at the “not voice” (if not voice) time. The voice other than target voice thus can be taken into consideration in the computation of the non-target sound source spatial feature.

### Spatial Filter Control Using SN Ratio-Maximizing Beam Former

The filter controller 114 controls the spatial filter using the sound source spatial feature estimated as described above. As an example, an SN ratio-maximizing beam former may be used. The SN ratio of each frequency, here, the energy ratio λ of the background noise to the target sound source signal + the background noise, can be estimated using spatial covariance R_{S} corresponding to the target sound source and spatial covariance R_{U} corresponding to the non-target sound source as in Equation (14) below:

$$λ = \frac{{w}^{H} {R}_{s} w}{{w}^{H} {R}_{U} w} . \qquad ( 14 )$$

Of λ and w that satisfy Equation (15) below representing a generalized eigenvalue problem, such w that maximizes λ is w (eigenvector) corresponding to the maximum λ (the maximum eigenvalue of the generalized eigenvalue problem). The generalized eigenvalue problem can be solved using any solution conventionally used.

R_{S}W=πR_{U}W (15)

Since the w (written as w_{SNRB}) obtained as described above has gain indefiniteness of the output signal, for example, a correction filter as illustrated in Equation (16) below is applied to minimize the error between the observation signal and the output signal:

$$b = \frac{{Rw}_{SNRB}}{{w}_{SNRB}^{H} {Rw}_{SNRB}} \qquad ( 16 )$$

where w_{SNRB}←bⱼW_{SNRB} is computed; R is the spatial covariance of the observation signal in Equation (8) and computed as the expected value in the segment including the present time of the observation signal; and bⱼ is any element in the vector b (the left side in Equation (16)) (j is an integer equal to or greater than one and equal to or smaller than the number of elements of the vector b). The thus-computed spatial filter w_{SNRB} can suppress the acoustic signal from the non -target sound source while retaining the acoustic signal of the target sound source.

### Spatial Filter Control Using Auxiliary Function-Based Independent Vector Analysis

As another example of the spatial filter control using the sound source spatial feature by spatial covariance, an applied method of independent vector analysis based on auxiliary function technique (auxiliary function-based independent vector analysis) will be illustrated. In estimation of the SN ratio-maximizing beam former, both of the spatial covariance Rₛ corresponding to the target sound source and the spatial covariance Rᵤ corresponding to the non-target sound source are required. The method using the auxiliary function-based independent vector analysis is an extended method of the blind sound source separation of estimating the spatial filter without preliminary information, using the spatial covariance matrix separately estimated as preliminary information. The spatial filter then can be estimated merely by giving the spatial covariance of one of the target sound source and the non-target sound source.

A combination with a method that performs the auxiliary function-based independent vector analysis in actual time is advantageous in that the target sound source can be estimated more accurately as the time passes, and in that the spatial variations of the target sound source and the non-target sound source after detection of utterance of a certain keyword can be followed.

There is known a technique that improves the SNR improvement performance of the auxiliary function-based independent vector analysis by referring to the non-voice spatial covariance during updating of the auxiliary variable in the auxiliary function-based independent vector analysis algorithm.

Also in the present embodiment, a desired spatial filter is formed similarly by referring to and using both or one of the spatial covariance of the target sound source spatial feature and the spatial covariance of non-target sound source spatial feature, during updating of the auxiliary variable in the auxiliary function-based independent vector analysis algorithm.

First, an overview of the algorithm of the auxiliary function-based independent vector analysis will be described. We will examine the question of how to obtain the spatial filter matrix in Equation (5) when the number M of microphones of the microphone array 101 is equal to the number K of sound sources. Here, such a spatial filter matrix is obtained that minimizes the objective function as illustrated by Equation (17) below (setting the question of independent vector analysis):

$$J ( W ) = {\sum }_{k = 1}^{K} \frac{1}{N} {\sum }_{n = 1}^{N} G ( {y}_{k} ( n ) ) - {\sum }_{ω = 1}^{L} log \vert det W ( ω ) \vert \qquad ( 17 )$$

where N is the time length of the observation signal referred to. In the case of the present embodiment, the observation signal is divided into appropriate time lengths to be used for estimation of W(ω). N corresponds to the length of the divided time. Given y(ω, n)=W(ω)x(ω, n), when the k-th element of y(ω, n) is yₖ(ω, n), then yₖ(n)=[yₖ(1, n); yₖ(2, n), . . . , yₖ(L, n)]^{T}.

G(′)is an appropriate contrast function having a vector as a factor. For example, a spherical contrast function as in Equation (18) below is used:

G(yₖ(n))=G_{R}(rₖ(n)) (18)

where rₖ(n) is expressed by Equation (19).

$${r}_{k} ( n ) = \sqrt{{\sum }_{ω = 1}^{L} {\vert {y}_{k} ( ω , n ) \vert}^{2}} = \sqrt{{\sum }_{ω = 1}^{L} {\vert {w}_{k}^{H} ( ω ) {x}^{H} ( ω , n ) \vert}^{2}} \qquad ( 19 )$$

Here, G_{R}(r) is a function in which G′_{R}(r)/r decreases monotonously when r is greater than zero. For example, G_{R}(r)=r is used. G′_{R}(r) is set as a derivative of G_{R}(r).

In this case, we will examine the updating rule for the auxiliary variable Vₖ(ω) and the spatial filter matrix W(ω) as in Equation (20) to Equation (22) below. It is noted that eₖ is a K-dimension column vector in which the k-th element alone is 1 and the other elements are 0.

$$\begin{matrix}{V}_{k} ( ω ) = \frac{1}{N} {\sum }_{n = 1}^{N} [ \frac{{G}_{R}^{′} ( {r}_{k} ( n ) )}{{r}_{k} ( n )} x ( ω , n ) {x}^{H} ( ω , n ) ] & ( 20 ) \\ {w}_{k} ( ω ) ← {( W ( ω ) {V}_{k} ( ω ) )}^{- 1} {e}_{k} & ( 21 ) \\ {w}_{k} ( ω ) ← {w}_{k} ( ω ) / \sqrt{{w}_{k}^{H} ( ω ) {V}_{k} ( ω ) {w}_{k} ( ω )} & ( 22 )\end{matrix}$$

Equation (20) to Equation (22) are repeatedly computed in order for all the frequencies and all the sound sources The objective function in Equation (17) is then reduced, resulting in such a spatial filter matrix that estimates K sound source signals k with filters.

Equation (23) below may be computed instead of Equation (20) only for a certain k=kₛ, using the spatial covariance R′_{U}(ω) computed as in Equation (11), from the non-voice segment separately obtained by VAD. The obtained spatial filter W_{kS} is able to enhance the voice accurately. Here, β is a real number that satisfies 1≦β<0.

$${V}_{k} ( ω ) = β {R}_{U}^{′} + ( 1 - β ) \frac{1}{N} {\sum }_{n = 1}^{N} [ \frac{{G}_{R}^{′} ( {r}_{k} ( n ) )}{{r}_{k} ( n )} x ( ω , n ) {x}^{H} ( ω , n ) ] \qquad ( 23 )$$

Similarly, in the present embodiment, the filter controller 114 executes computations as illustrated in Equations (24) and (25) below, using the spatial covariance R_{S} corresponding to the target sound source and the spatial covariance Rᵤ corresponding to the non-target sound source.

$$\begin{matrix}{V}_{k} ( ω ) = β {R}_{U} + ( 1 - β ) \frac{1}{N} {\sum }_{n = 1}^{N} [ \frac{{G}_{R}^{′} ( {r}_{k} ( n ) )}{{r}_{k} ( n )} x ( ω , n ) {x}^{H} ( ω , n ) ] ( k = {k}_{s} ) & ( 24 ) \\ {V}_{k} ( ω ) = β {R}_{s} + ( 1 - β ) \frac{1}{N} {\sum }_{n = 1}^{N} [ \frac{{G}_{R}^{′} ( {r}_{k} ( n ) )}{{r}_{k} ( n )} x ( ω , n ) {x}^{H} ( ω , n ) ] ( k \neq {k}_{s} ) & ( 25 )\end{matrix}$$

Here, when β=1, a spatial filter similar to the SN ratio-maximizing beam former can be obtained. When 0<β<1, a spatial filter in consideration of the observation signal of interest can be obtained. This is useful when an environment change occurs from the observation signal used for computations of Rₛ and Rᵤ.

As illustrated in Equation (24) and Equation (25), when k=k_{S}, Equation (24) is applied instead of Equation (20). When k≠k_{S}, Equation (25) is applied instead of Equation (20). In a case where the target sound source spatial feature alone is used, the filter controller 114 may apply Equation (24) instead of Equation (20) when k=kₛ, and may apply Equation (20) when k≠k_{S}. In a case where the non-target sound source spatial feature alone is used, the filter controller 114 may apply Equation (20) when k=kₛ, and may apply Equation (25) instead of Equation (20) when k≠kₛ.

The filter controller 114 may further use the spatial covariance Rₛ corresponding to the target sound source and the spatial covariance Rᵤ corresponding to the non-target sound source, for the extended method of the auxiliary function-based independent vector analysis for actual time processing, as illustrated in Japanese Patent Application Laid-open No. 2014-041308.

In the auxiliary function-based independent vector analysis for actual time processing, an appropriate spatial filter matrix W (ω) at each time can be computed by sequentially updating the auxiliary variable Vₖ(ω;n) at time n as in Equation (26) below, instead of Equation (20).

$${V}_{k} ( ω ; n ) = β \cdot {V}_{k} ( ω ; n - 1 ) + ( 1 - β ) \cdot \frac{{G}^{′} ( {r}_{k} ( n ) )}{{r}_{k} ( n )} x ( ω , n ) {x}^{H} ( ω , n ) \qquad ( 26 )$$

Here, the spatial filter obtained by applying Equation (27) and Equation (28) below at appropriate time n, instead of Equation (26) is able to enhance the voice accurately. After time n, the spatial filter can be controlled so as to be adapted to environmental changes such as movement of the target user or changes in background noise, by using Equation (26).

$$\begin{matrix}{V}_{k} ( ω ; n ) = β \cdot {R}_{U} + ( 1 - β ) \cdot \frac{{G}^{′} ( {r}_{k} ( n ) )}{{r}_{k} ( n )} x ( ω , n ) {x}^{H} ( ω , n ) ( k = {k}_{s} ) & ( 27 ) \\ {V}_{k} ( ω ; n ) = β \cdot {R}_{s} + ( 1 - β ) \cdot \frac{{G}^{′} ( {r}_{k} ( n ) )}{{r}_{k} ( n )} x ( ω , n ) {x}^{H} ( ω , n ) ( k \neq {k}_{s} ) & ( 28 )\end{matrix}$$

The filter controller 114 may make updates while further adding the auxiliary variable Vₖ(ω; n−1) at the immediately preceding time (n−1), as in Equation (29) and Equation (30) below. Here, γ is a real number that satisfies0≦γ<1.

$$\begin{matrix}{V}_{k} ( ω ; n ) = β {R}_{U} + γ {V}_{k} ( ω ; n - 1 ) + ( 1 - β - γ ) \frac{{G}^{′} ( {r}_{k} ( n ) )}{{r}_{k} ( n )} x ( ω , n ) {x}^{H} ( ω , n ) ( k = {k}_{s} ) & ( 29 ) \\ {V}_{k} ( ω ; n ) = β {R}_{s} + γ {V}_{k} ( ω ; n - 1 ) + ( 1 - β - γ ) \frac{{G}^{′} ( {r}_{k} ( n ) )}{{r}_{k} ( n )} x ( ω , n ) {x}^{H} ( ω , n ) ( k \neq {k}_{s} ) & ( 30 )\end{matrix}$$

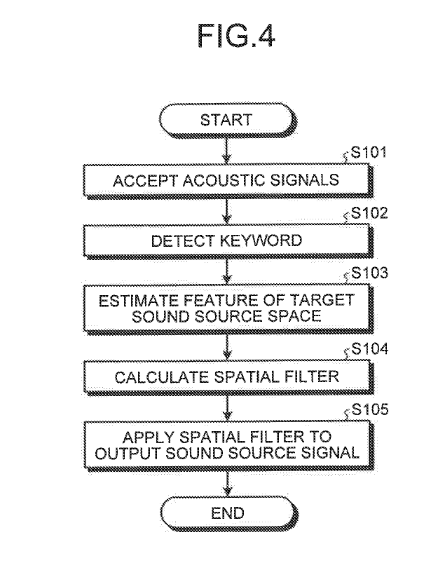

The voice processing by the information processing apparatus 100 according to the present embodiment will be described with reference to FIG. 4. FIG. 4 is a flowchart illustrating an example of the voice processing in the present embodiment. FIG. 4 illustrates an example of the voice processing using the target sound source spatial feature.

The accepting unit 111 accepts input of input acoustic signals from the microphone array 101 (step S101. The detector 112 detects a certain keyword and a keyword speech segment in which the keyword is output, based on the input acoustic signals (step S102).

The calculator 113 estimates the target sound source spatial feature, based on a plurality of input acoustic signals and the keyword speech segment (step S103). The filter controller 114 calculates (generates) a spatial filter, using the estimated target sound source spatial feature (step S104). For example, the filter controller 114 obtains a spatial filter by applying Equation (24) instead of Equation (23) when k=kₛ or applying Equation (23) when k≠kₛ. The filter controller 114 applies the obtained spatial filter to process the input acoustic signals and outputs the resulting sound source signal (step S105).

The voice processing using the non-target sound source spatial feature alone may be performed using the non-target sound source spatial feature instead of the target sound source spatial feature at step S103 and step S104.

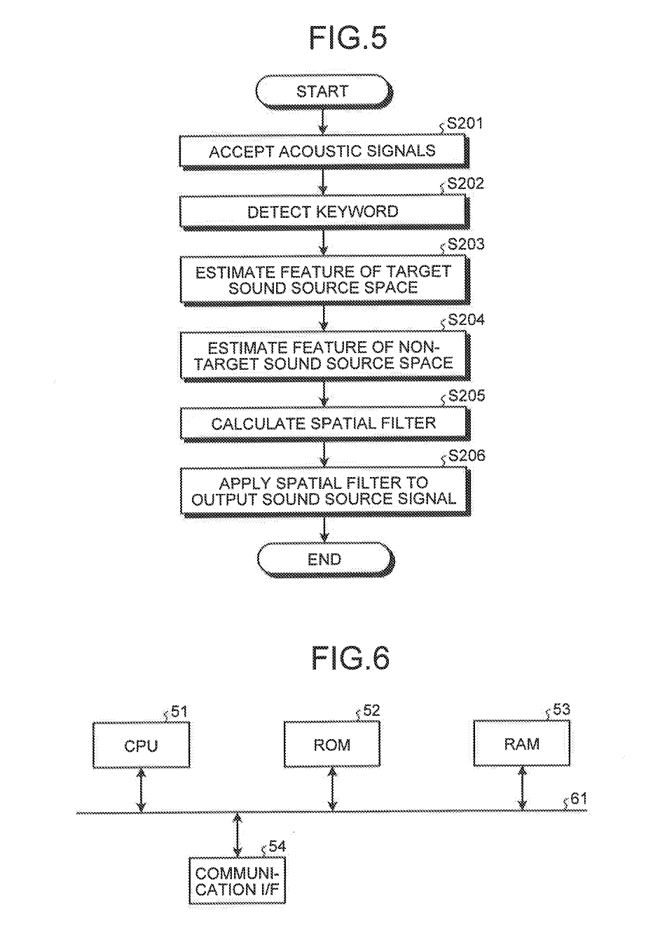

The voice processing using both of the target sound source spatial feature and. the non-target sound source spatial feature will now be describe., FIG. 5 is a flowchart illustrating an example of the voice processing in the present embodiment in this case,

Step S201 to step S203 are similar to step S101 to step S103 in FIG. 4.

The calculator 113 further estimates the non-target sound source spatial feature (step S204). The filter controller 114 calculates (generates) a spatial filter, using the estimated target sound source spatial feature and non-target sound source spatial feature (step S205., For example, when the SN ratio-maximizing beam former is used, the filter controller 114 calculates a spatial filter by Equation (14) to Equation (16) above. For example, when the auxiliary function-based independent vector analysis is used, the filter controller 114 calculates a spatial filter by Equation (24) and Equation (25) above, or Equation (27) and Equation (28) , or Equation (29) and Equation (30), in addition to Equation (19) and Equations (21) and (22) above. The order in which step S203 and step S204 are executed may be reversed, or step S203 and step S204 may be executed concurrently.

Step S206 is similar to step S105 in FIG. 4.

In this manner, in the information processing apparatus according to the present embodiment, a spatial filter is calculated by using the sound source spatial feature including acoustic characteristics of a space including a sound source and a microphone array. This enables designing of a spatial filter in common situations in which target sound and non-target sound are observed in a mixed state. The present embodiment does not require the premise of a special situation in which both sound sources can be exclusively observed as in Japanese Unexamined Patent Application Publication No. 2005-529379. This enables generation of a spatial filter capable of obtaining target sound appropriately even in more common situations.

The hardware configuration of the information processing apparatus according to the present embodiment will now be described with reference to FIG. 6. FIG. 6 is an illustration of a hardware configuration example of the information processing apparatus according to the present embodiment.

The information processing apparatus according to the present embodiment includes a control device such as a CPU 51, a storage device such as a read only memory (ROM) 52 and a random access memory (RAM) 53, a communication interface (I/F) 54 connecting to a network for communication, and a bus 61 connecting the units.

The program to be executed in the information processing apparatus according to the present embodiment is built in the ROM 52 or the like in advance.

The program to be executed in the information processing apparatus according to the present embodiment may be configured to be stored on a computer-readable recording medium such as a compact disc read only memory (CD-ROM), a flexible disk (FD)), a compact disc recordable (CD-R), and a digital versatile disc (DVD) in an installable format or an executable format and provided as a computer program product.

The program to be executed in the information processing apparatus according to the present embodiment may be configured to be stored in a computer connected to a network such as the Internet, and downloaded via the network. The program to be executed in the information processing apparatus according to the present embodiment may be configured to be provided or distributed via a network such as the Internet.

The program to be executed in the information processing apparatus according to the present embodiment may cause a computer to function as the aforementioned units of the information processing apparatus. The computer may execute the program read by the CPU 51 from a computer-readable storage medium onto a main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a detector configured to detect a segment in which a keyword is included, based on at least one of input acoustic signals input from M (an integer equal to or greater than two) voice input units;
a calculator configured to calculate an M×M spatial feature matrix including acoustic characteristics of a space including a first sound source of interest and a second sound source other than the first sound source, and acoustic characteristics based on positional relation between the voice input units and one or more of the first sound source and the second sound source, based, on the input acoustic signals and the segment; and
a generator configured to generate a spatial filter for obtaining an acoustic signal from the input acoustic signals, based on the spatial feature matrix, the acoustic signal being output from the first sound source.

2. The information processing apparatus according to claim 1, wherein the calculator calculates a first spatial feature matrix including acoustic characteristics of the first sound source in the space and acoustic characteristics based on positional relation between the first sound source and the voice input units.

3. The information processing apparatus according to claim 2, wherein. the calculator calculates the first spatial feature matrix based on the input acoustic signals input in the detected segment.

4. The information processing apparatus according to claim 1, wherein the calculator calculates a second spatial feature matrix including acoustic characteristics of the second sound source in the space and acoustic characteristics based on positional relation between the second sound source and the voice input units.

5. The information processing apparatus according to claim 4, wherein the calculator calculates the second spatial feature matrix based on the input acoustic signals input in at least one of segments before and after the detected segment.

6. The information processing apparatus according to claim 4, wherein the calculator calculates the second spatial feature matrix based on the input acoustic signals input in a non-voice segment, of at least one of segments before and after the detected segment.

7. The information processing apparatus according to claim 1, wherein
the calculator calculates a first spatial feature matrix including acoustic characteristics of the first sound source in the space and acoustic characteristics based on positional relation between the first sound source and the voice input units, and a second spatial feature matrix including acoustic characteristics of the second sound source in the space and acoustic characteristics based on positional relation between the second sound source and the voice input units, and
the generator generates the spatial filter based on the first spatial feature matrix and the second spatial feature matrix.

8. The information processing apparatus according to claim 1, wherein the generator generates the spatial filter using a signal-noise (SN) ratio-maximizing beam former.

9. The information processing apparatus according to claim 1, wherein the generator generates the spatial filter using independent vector analysis based on auxiliary function technique.

10. The information processing apparatus according to claim 1, wherein the calculator calculates the spatial feature matrix using the input acoustic signals input at a first time and the input acoustic signals input at a second time after the first time.

11 The information processing apparatus according to claim 1, wherein the acoustic characteristics based on positional relation are acoustic characteristics based on a position with reference to the voice input units.

12. An information processing method comprising
detecting a segment in which a keyword is included, based on at least one of input acoustic signals input from M (an integer equal to or greater than two) voice input units;
calculating an M×M spatial feature matrix including acoustic characteristics of a space including a first sound source of interest and a second sound source other than the first sound source and acoustic characteristics based on positional relation between the voice input unfits and one or more of the first sound source and the second sound source, based on the input acoustic signals and the segment; and
generating a spatial filter for obtaining an acoustic signal from the input acoustic signals, based on the spatial feature matrix, the acoustic signal being output from the first sound source.

13. A computer program product comprising a non-transitory computer-readable recording medium that stores therein a computer program for causing a computer to execute:
detecting a segment in which a keyword is included, based on at least one of input acoustic signals input from M (an integer equal to or greater than two) voice input units;
calculating an M×M spatial feature matrix including acoustic characteristics of a space including a first sound source of interest and a second sound source other than the first sound source and acoustic characteristics based on positional relation between the voice input units and one or more of the first. sound source and the second sound source, based on the input acoustic signals and the segment; and
generating a spatial filter for obtaining an acoustic signal from the input. acoustic signals, based on the spatial feature matrix, the acoustic signal being output from the first sound source.
